(19) United States
(12) Patent Application Publication
(10) Pub. No.: US 2018/0326908 A1
(43) Pub. Date: Nov. 15, 2018

(54) ADAPTIVE BABY MONITORING APPARATUS AND METHOD

(71) Applicant: FORD GLOBAL TECHNOLOGIES, LLC, Dearborn, MI (US)

(72) Inventors: Paul Pagnoulle De la Rosa, Ciudad de México (MX); Carlos Hernandez, Ciudad de México (MX); Jeronimo Ramos, Ciudad de México (MX); Alvaro Jimenez Hernandez, Ciudad de México (MX)

(21) Appl. No.: 15/593,749

(22) Filed: May 12, 2017

(51) Int. Cl. B60R 1/00; B60N 2/48; B60R 1/04; B60R 1/12

(52) U.S. Cl. CPC B60R 1/008; B60N 2/48; B60N 2/4876; B60R 1/12; B60R 1/04

(57) ABSTRACT

An apparatus is provided for monitoring a baby in a rear facing baby seat. That apparatus includes a headrest, a mirror carried on the headrest and a control module. The control module is configured to adjust the orientation or position of the mirror about a first axis and a second axis to allow the best possible viewing of the baby. A related method is also disclosed.

### TECHNICAL FIELD

This document relates generally to the motor vehicle equipment field and, more particularly, to an adaptive apparatus and method for monitoring a baby in a rear facing baby or child seat.

### BACKGROUND

Operators of motor vehicles around the world put their babies under two years of age in rear facing child or baby seats due to government regulation and for the baby's own safety. When the baby is oriented in this manner in a child or baby safety seat positioned in the rear seat of a motor vehicle, it is not possible for a driver in the front row of seating to observe the baby's face to monitor the baby's emotions, reactions and current condition.

This document relates to a new and improved adaptive apparatus and method allowing a driver of a motor vehicle to easily observe the face of a rear facing baby in a rear seat of the motor vehicle and monitor the condition of that baby using a mirror. Advantageously, the mirror may be remotely oriented to ensure a desired visual field for monitoring the baby.

### SUMMARY

In accordance with the purposes and benefits described herein, an apparatus is provided for monitoring a baby in a rear facing baby seat. That apparatus comprises a headrest, a mirror carried on the headrest and a control module. The control module is configured to adjust position or orientation of the mirror about a first axis and a second axis so as to allow an operator to better visually monitor the face of the baby in a rear facing baby seat.

The control module may include a first drive mechanism to adjust the mirror about the first axis. Further, the control module may include a second drive mechanism to adjust the mirror about the second axis.

Still further, the control module may include a controller. In addition, the control module may include an input device remote from the headrest so that, for example, the individual operator may adjust the position of the mirror from the driver's seat of the motor vehicle. That input device may be an actuator button. In other embodiments, that input device may be a voice processor. In some embodiments, the control module may be configured for a wireless communication between the remote input device and the controller.

In some embodiments, the apparatus may include a cover on the headrest. That cover may be displaceable between a home position covering the mirror and a use position exposing the mirror for viewing. In such an embodiment the control module may be configured to displace the cover between the home position and the use position. Further, the control module may include a cover actuator for physically displacing the cover between the home position and the use position.

In accordance with an additional aspect, a method is provided for monitoring a baby held in a rearward facing baby or child seat such as one secured in a rear seat of a motor vehicle. That method comprises the steps of locating a mirror in a headrest on the rear seat and configuring a control module to adjust orientation of the mirror in order to provide a useful viewing angle of the baby.

The method may further include the step of locating an input device of the control module within reach of a motor vehicle driver whereby the motor vehicle driver may remotely adjust the orientation of the mirror from a seated position in a driver's seat of the motor vehicle.

The method may also include the step of configuring the control module for adjusting the orientation of the mirror in response to voice command.

In accordance with yet another aspect, a method is provided of monitoring a baby in a rearward facing child seat secured in a rear seat of a motor vehicle. That method comprises remotely adjusting, by control module, the orientation of a mirror in a rear seat headrest from a driver's seat of the motor vehicle. Further, that method may include the step of using voice command to remotely adjust the mirror. Alternatively, or in addition the method may include the step of using an input device remote from the mirror to remotely adjust the mirror.

The method may also include the step of flipping, by the control module, the headrest from a home position wherein the mirror faces rearward away from the baby to a deployed position wherein the mirror faces forward toward the baby. In some embodiments the method may include the step of opening a cover on the headrest, by the control module, in order to uncover the mirror for viewing.

In the following description, there are shown and described several preferred embodiments of the adaptive apparatus and method for monitoring a baby in a rear facing baby or child safety seat. As it should be realized, the apparatus and method are capable of other, different embodiments and their several details are capable of modification in various, obvious aspects all without departing from the apparatus and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the apparatus and method and together with the description serve to explain certain principles thereof.

FIG. 1 is a schematic block diagram of the adaptive apparatus for monitoring a baby in a rear facing baby or child safety seat.

FIGS. 2a and 2b illustrate a first embodiment of the apparatus wherein a baby monitoring mirror is provided in the rear face of the headrest. FIG. 2a illustrates the front face of the headrest when the headrest is in the home position. FIG. 2b illustrates that the headrest may be rotated 180 degrees and remounted to the seat with the baby monitoring mirror now oriented toward the front of the vehicle where it may be utilized by one in a forward position of the motor vehicle to monitor the face of a baby in a rear facing child or baby safety seat.

FIGS. 3a and 3b illustrate an alternative embodiment of the apparatus wherein the headrest includes a cover that may be closed as illustrated in FIG. 3a to conceal the baby monitoring mirror and opened as illustrated in FIG. 3b to expose the baby monitoring mirror for use.

FIG. 3c is a view of a touchscreen in the center console of the motor vehicle that may be utilized as a remote input device to control the position or orientation of the baby monitoring mirror from the driver's seat of the motor vehicle.

FIGS. 4a and 4b illustrate yet another alternative embodiment wherein the baby monitoring mirror is provided in the rear face of the headrest which may be flipped forward to place the mirror in a baby monitoring position and an input device in the form of four-way adjustment button may be utilized to provide the proper viewing angle for monitoring the face of the baby from the driver's seat of the motor vehicle.

Reference will now be made in detail to the present preferred embodiments of the apparatus and method, examples of which are illustrated in the accompanying drawing figures.

### DETAILED DESCRIPTION

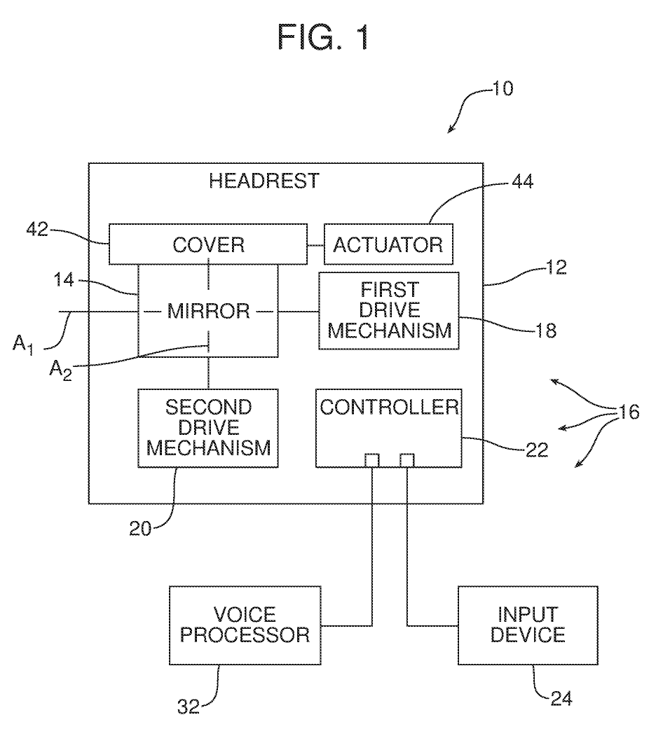

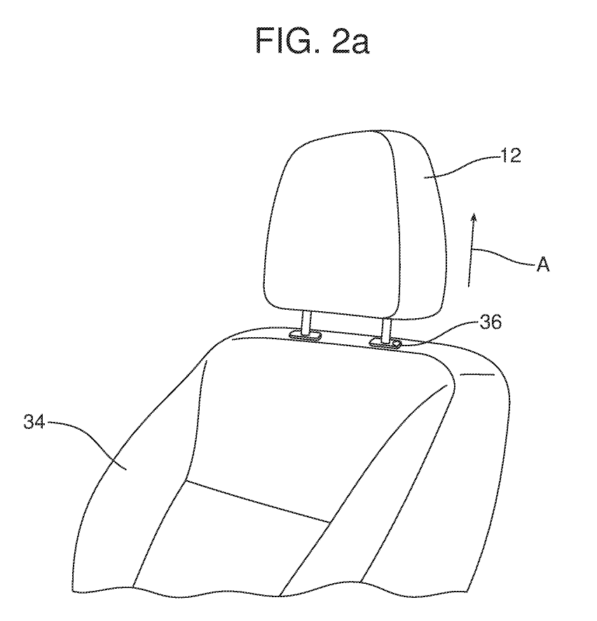

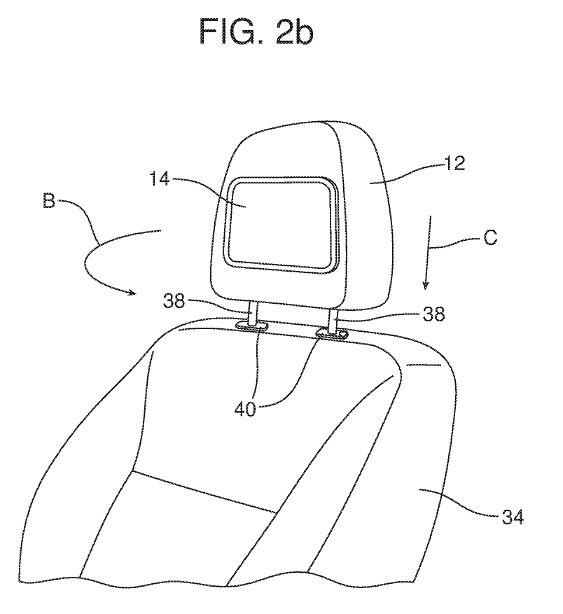

Reference is now made to FIGS. 1, 2a and 2b illustrating a first embodiment of the adaptive apparatus 10 which allows one to monitor a baby in a rear facing child or baby safety seat from, for example, the driver's seat of a motor vehicle. As illustrated, the apparatus 10 includes a headrest 12 and a mirror 14 carried on the headrest. A control module, generally designated by reference numeral 16, is configured to adjust the position or orientation of the mirror 14 about a first axis A₁ and a second axis A₂ wherein the first and second axis are substantially perpendicular to one another.

More specifically, the control module 16 includes a first drive mechanism 18 to adjust the mirror 14 about the first axis A₁. In addition, the control module 16 includes a second drive mechanism 20 to adjust the position of the mirror 14 about the second axis A₂. The first and second drive mechanisms 18, 20 are of a type known in the art such as utilized to remotely control the position of a side mirror of a motor vehicle.

As further illustrated in FIG. 1, the control module 16 includes a controller 22. The controller 22 comprises a computing device such as a dedicated microprocessor or electronic control unit (ECU) operating in accordance with instructions from appropriate control software. Accordingly, the controller 22 may comprise one or more processors, one or more memories and one or more network interfaces all in communication with each other over a communication bus.

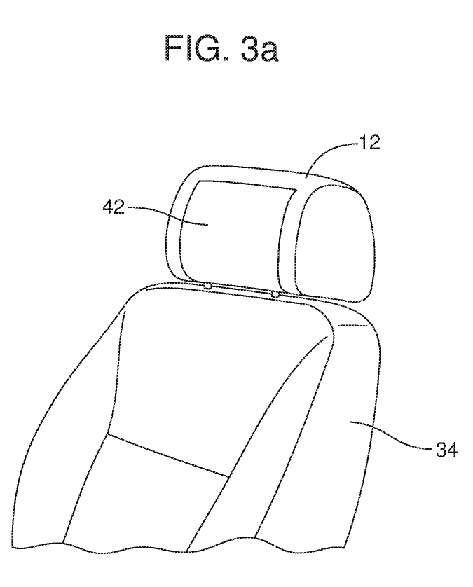

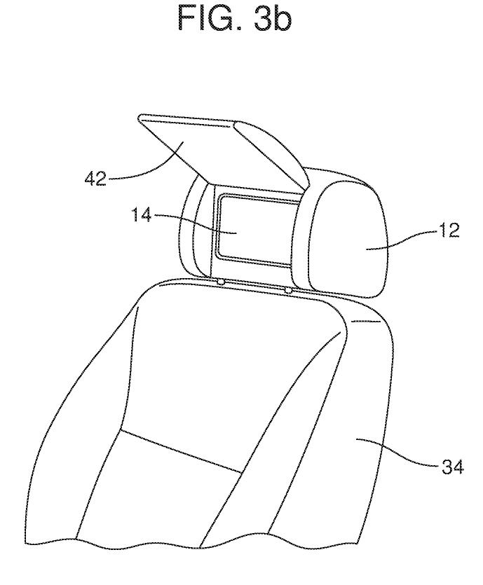

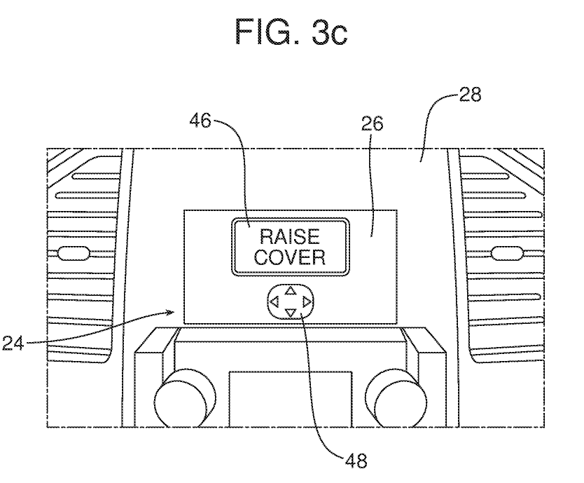

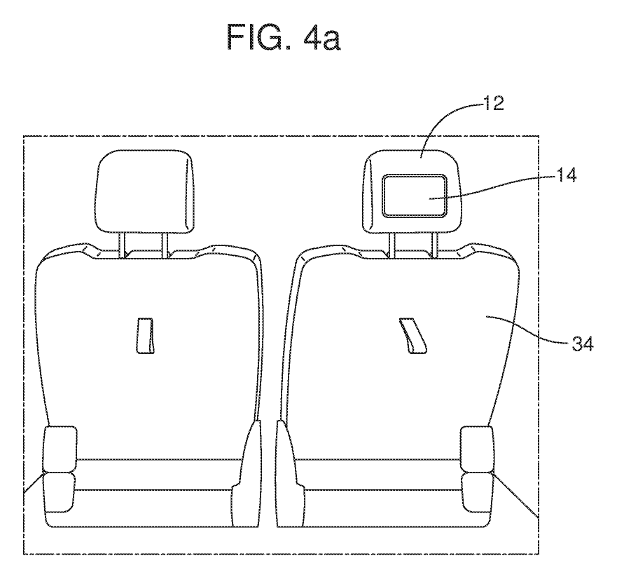

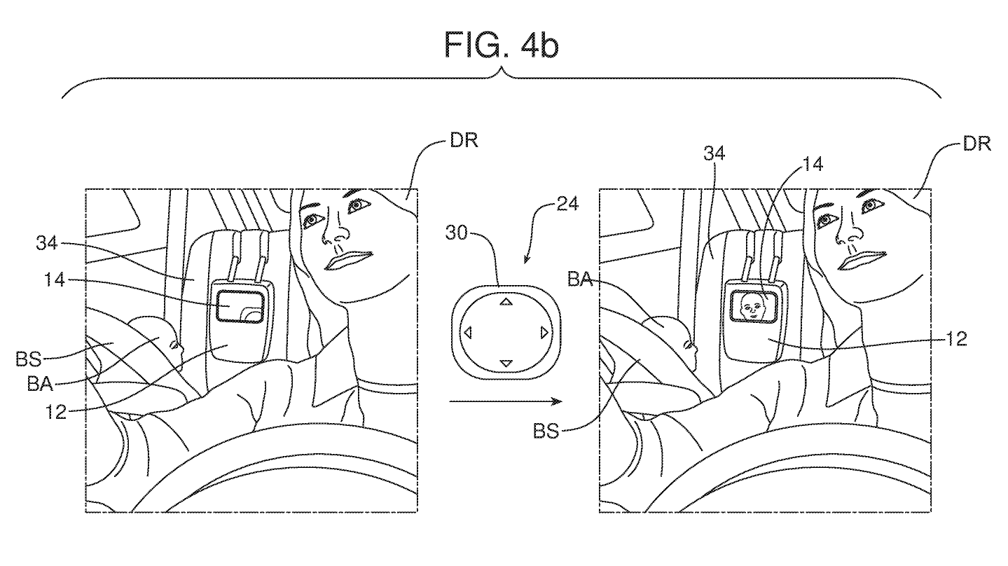

The control module 16 also includes an input device 24 that may be remote from the headrest 12. As illustrated in FIG. 3c, the input device 24 may comprise a touchscreen 26 in the center stack 28 of the motor vehicle within easy reach of the driver in the driver seat of the motor vehicle. In other embodiments as illustrated in FIG. 4b, the input device 24 may comprise a joystick actuator button 30. In addition, as further illustrated in FIG. 1, the control module may include a voice processor 32 connected to the controller 22 and allowing an operator to utilize voice commands to control the position or orientation of the mirror 14.

As illustrated in one possible embodiment in FIGS. 2a and 2b, the mirror 14 is provided in the rear face of the headrest 12. Accordingly, when the headrest 12 is in the home position at the top of the back of the rear seat 34, the mirror 14 is oriented rearward so as to be hidden from view in this figure. When one wishes to utilize the mirror 14 to monitor a baby in a child or baby safety seat held in the rear seat 34, one engages the headrest release button 36, removes the headrest 12 from the rear seat by lifting in the direction of action arrow A, rotates the headrest through 180 degrees as illustrated by action arrow B in FIG. 2b and then reattaches the headrest 12 to the rear seat 34 by aligning and inserting the stalks 38 in the receivers 40 at the top of the rear seat (note action arrow C). When this is done the mirror 14 now faces forward and is in a position to be utilized to monitor a baby in a rear facing child or baby safety seat held in the seat 34. Significantly, such a headrest 12 could be removed and positioned in a baby monitoring position at the top of any seat in the motor vehicle. In order to allow for this functionality, the control module 16 would be configured for wireless communication between the input device 24 and the control module 16 so that remote positioning and orientation of the mirror 14 about the first axis A₁ and second axis A₂ would be possible.

Reference is now made to FIGS. 3a-3c illustrating an alternative embodiment of the apparatus 10 wherein the headrest 12 includes a cover 42 that is displaceable between a home position covering the mirror 14 as illustrated in FIG. 3a and a use position exposing the mirror for viewing as illustrated in FIG. 3b. As illustrated in FIG. 1, in such an embodiment, the control module 16 may further include an actuator 44 connected to the cover 42. That actuator 44 is responsive to the controller 22 to displace the cover 42 between the home position and the use position upon command of the operator of the apparatus 10. As illustrated in FIG. 3c, the touchscreen 26 at the center stack 28 may be utilized by the motor vehicle driver to open or close the cover 42 by means of the touch button 46 and adjust the position of the mirror 14 by means of the touch button 48 through operation of the first and second drive mechanisms 18, 20 from the driver's seat of the motor vehicle. Once the mirror 14 is properly oriented, the driver may view the face of baby in the rear facing child or baby safety seat by, for example, glancing in the rearview mirror and viewing the reflection of the baby's face in the baby monitoring mirror 14.

Yet another embodiment of the apparatus is illustrated in FIGS. 4a and 4b. In this embodiment, the mirror 14 is provided on the rear side of the headrest 12. When one wishes to monitor a baby BA in a rear facing child or baby safety seat BS, one flips the headrest 12 forward into the position illustrated in FIG. 4b so that the mirror 14 on the rear face of the headrest 12 now faces forward. One may then adjust the position or orientation of the mirror 14 for viewing the face of the baby BA by means of, for example, the actuator button 30 which provides for adjustment of the position of the mirror about the first axis A₁ through operation of the first drive mechanism 18 and the second axis A₂ through operation of the second drive mechanism 20 both under the control of the controller 22. As should be appreciated, the actuator button 30 is positioned within easy reach of the driver DR of the motor vehicle when seated in the driver seat. When the mirror 14 is properly oriented, the driver DR may glance into the rearview mirror and see the reflection of the baby's face in the baby monitoring mirror 14 on the headrest 12.

Consistent with the above description, a method is provided for monitoring a baby held in a rear facing child seat secured in a rear seat of a motor vehicle. That method may be described as comprising the steps of locating a mirror 14 in a headrest 12 on the rear seat 34 and configuring a control module 16 to adjust the orientation of the mirror in order to provide a viewing angle of the baby.

Further, the method may include the step of locating an input device 24 of the control module 16 within reach of a motor vehicle driver whereby the motor vehicle driver may remotely adjust the orientation of the mirror from a driver's seat of the motor vehicle. In some embodiments, the method may include configuring the control module 16 for adjusting the orientation of the mirror 14 in response to voice command via a voice processor 32. Still further, a method of monitoring a baby in a rearward facing child seat secured in a rear seat of a motor vehicle may comprise remotely adjusting, by control module 16 the orientation of the mirror 14 from a driver's seat in the motor vehicle. That method may include using voice command to remotely adjust the mirror via operation of a voice processor 32. Alternatively, the method may include using an input device 24 remote from the mirror 14 to remotely adjust the mirror.

Still further, as illustrated in FIGS. 4a and 4b the method may include the step of flipping the headrest 12 from a home position wherein the mirror faces rearward away from the baby to a deployed position wherein the mirror faces forward toward the baby. This flipping may be done by operation of the control module 16 by means of an additional actuator (not shown) connected to the headrest 12.

Still further, as illustrated in FIGS. 3a and 3b the method may include the step of opening a cover 42 on the headrest 12 by means of the control module 16 and the actuator 44 to uncover the mirror for viewing.

The foregoing has been presented for purposes of illustration and description. It is not intended to be exhaustive or to limit the embodiments to the precise form disclosed. Obvious modifications and variations are possible in light of the above teachings. For example, the input device may comprise a cell phone operating an app configured to communicate with the control module 16 and position or orient the mirror 14 for viewing the baby. All such modifications and variations are within the scope of the appended claims when interpreted in accordance with the breadth to which they are fairly, legally and equitably entitled.

What is claimed:

1. An apparatus, comprising:
a headrest;
a mirror carried on said headrest; and
a control module configured to adjust said mirror about a first axis and a second axis.

2. The apparatus of claim 1, wherein said control module includes a first drive mechanism to adjust said mirror about said first axis.

3. The apparatus of claim 2, wherein said control module includes a second drive mechanism to adjust said mirror about said second axis.

4. The apparatus of claim 3, wherein said control module includes a controller.

5. The apparatus of claim 4, wherein said control module includes an input device remote from said headrest.

6. The apparatus of claim 5, wherein said input device is an actuator button.

7. The apparatus of claim 5, wherein said input device is a voice processor.

8. The apparatus of claim 5, wherein said control module is configured for wireless communication between said input device and said controller.

9. The apparatus of claim 5, further including a cover on said headrest, said cover being displaceable between a home position covering said mirror and a use position exposing said mirror for viewing.

10. The apparatus of claim 9, wherein said control module is configured to displace said cover between said home position and said use position.

11. The apparatus of claim 10, wherein said control module includes a cover actuator.

12. A method of monitoring a baby held in a rearward facing child seat secured to a rear seat of a motor vehicle, comprising:
locating a mirror in a headrest on said rear seat; and
configuring a control module to adjust orientation of said mirror in order to provide a viewing angle of said baby.

13. The method of claim 12, including locating an input device of said control module within reach of a motor vehicle driver whereby said motor vehicle driver may remotely adjust said orientation of said mirror from a driver's seat of said motor vehicle.

14. The method of claim 12, including configuring said control module for adjusting said orientation of said mirror in response to voice command.

15. A method of monitoring a baby held in a rearward facing child seat secured in a rear seat of a motor vehicle, comprising:
remotely adjusting by control module, orientation of a mirror in a rear seat headrest from a driver's seat of said motor vehicle.

16. The method of claim 15, including using voice command to remotely adjust said mirror.

17. The method of claim 15, including using an input device remote from said mirror to remotely adjust said mirror.

18. The method of claim 17, including flipping, by said control module, a head rest from a home position wherein said mirror faces rearward to a deployed position wherein said mirror faces forward toward said baby.

19. The method of claim 18, including opening a cover on said headrest, by said control module, to uncover said mirror for viewing.

20. The method of claim 12, including opening a cover on said headrest, by said control module, to uncover said mirror for viewing.
